(19) United States
(12) Patent Application Publication
(10) Pub. No.: US 2019/0265806 A1
(43) Pub. Date: Aug. 29, 2019

(54) VIRTUAL REALITY ENCLOSURES WITH MAGNETIC FIELD SENSING

(71) Applicant: INTERDIGITAL CE PATENT HOLDINGS, Paris (FR)

(72) Inventor: Kent LYONS, Mountain View, CA (US)

(21) Appl. No.: 16/331,028

(22) PCT Filed: Aug. 31, 2017
(86) PCT No.: PCT/US17/49627

§ 371 Date: Mar. 6, 2019

Related U.S. Application Data
(60) Provisional application No. 62/383,873, filed on Sep. 6, 2016.

(51) Int. Cl. G06F 3/0346; G02B 27/01; G06F 3/01; H04N 13/344

(52) U.S. Cl. CPC G06F 3/0346; G02B 27/017; G02B 2027/0187; H04N 13/344; G06F 3/012

(57) ABSTRACT

An apparatus and method is provided for determining user input. In one embodiment, the method comprises receiving continuous total magnetic field readings via a processor, wherein some of the magnetic field measurements are due to a magnet connected to a user interface and input to the user interface causes positional changes to said magnet. The processor removes any ambient magnetic field components from the magnetic field readings and analyzes changes in the magnetic field readings to determine when the changes are due to positional changes of a magnet in proximity to the user interface. The processor also initiates at least one command based on tracking positional changes of the magnet.

### TECHNICAL FIELD

The present invention relates generally to Virtual reality and in particular to a reactive animation enhanced Virtual Reality

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In recent years, Virtual Reality (VR) has become the subject of increased attention. This is because VR can be used practically in every field to perform various functions including testing, entertaining and teaching. For example, engineers and architects can use VR in modeling and testing of new designs. Doctors can use VR to practice and perfect difficult operations ahead of time and military experts can develop strategies by simulating battlefield operations. VR is also used extensively in the gaming and entertainment industries to provide interactive experiences and enhance audience enjoyment. VR enables the creation of a simulated environment that feels real and can accurately duplicate real life or fictional situations. Furthermore, VR covers remote communication environments which provide virtual presence of users with the concepts of tele-presence and tele-existence or virtual artifact (VA). VR also provides a better sense of design and engineering because in many instances it allows conversion of two dimensional images into visually accessible three dimensional virtual structures. Most prior art VR devices, are cumbersome and expensive. The changes presented by mobile device technology has offered virtual reality applications with more accessible alternatives. Consequently, in recent years, however, it has become desirous to provide VR functions through incorporating everyday personal mobile devices such as cellular phones so as to improve accessibility and availability.

### SUMMARY

Additional features and advantages are realized through the techniques of the present invention. Other embodiments and aspects of the invention are described in detail herein and are considered a part of the claimed invention. For a better understanding of the invention with advantages and features, refer to the description and to the drawings.

An apparatus and method is provided for determining user input. In one embodiment, the method comprises receiving continuous total magnetic field readings via a processor, wherein some of the magnetic field measurements are due to a magnet connected to a user interface and input to the user interface causes positional changes to said magnet. The processor removes any ambient magnetic field components from the magnetic field readings and analyzes changes in the magnetic field readings to determine when the changes are due to positional changes of a magnet in proximity to the user interface. The processor also initiates at least one command based on tracking positional changes of the magnet.

### BRIEF DESCRIPTION OF THE DRAWINGS

The present disclosure will be better understood and illustrated by means of the following embodiment and execution examples, in no way limitative, with reference to the appended figures on which:

FIG. 1 is an illustration of a virtual reality (VR) enclosure that has been enhanced as per one embodiment;

FIG. 2 is a graphical depiction of a magnetic field such as one generated by the magnet shown in conjunction with the embodiment of FIG. 1;

FIG. 3 is a graphical depiction showing the relationship between the magnitude of the magnetic field and the strength and distance of the magnet as discussed in conjunction with FIGS. 1 and 2;

FIG. 4 is a graphical illustration showing the impact of ambient magnetic field on distance calculation as per embodiment of FIG. 3;

FIG. 5 is an illustration of a diagram representing a visualization of an exemplary test conducted as per one embodiment;

FIG. 6 is a graphical depiction of the results of the experiment conducted as per embodiment of FIG. 5;

FIG. 7 is an illustration of an example depicting an interface device in use while drawing a spiral shape according to one embodiment;

FIG. 8 is an example of three different inputs using different interface devices in drawing shapes using directional gestures as per one embodiment;

FIG. 9 is an illustration of an experimental setup as per the embodiment of FIG. 1;

FIG. 10 is a block diagram of a computer system such as used in conjunction with different embodiments; and

FIG. 11 is a flow chart of a methodology for providing user interface using a virtual reality enclosure according to one embodiment.

Wherever possible, the same reference numerals will be used throughout the figures to refer to the same or like parts.

### DESCRIPTION

It is to be understood that the figures and descriptions of the present invention have been simplified to illustrate elements that are relevant for a clear understanding of the present invention, while eliminating, for purposes of clarity, many other elements found in typical digital multimedia content delivery methods and systems. However, because such elements are well known in the art, a detailed discussion of such elements is not provided herein. The disclosure herein is directed to all such variations and modifications known to those skilled in the art.

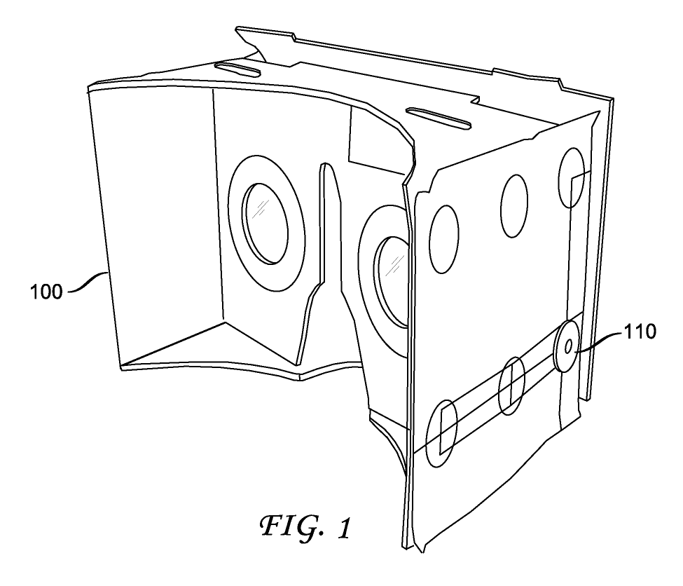

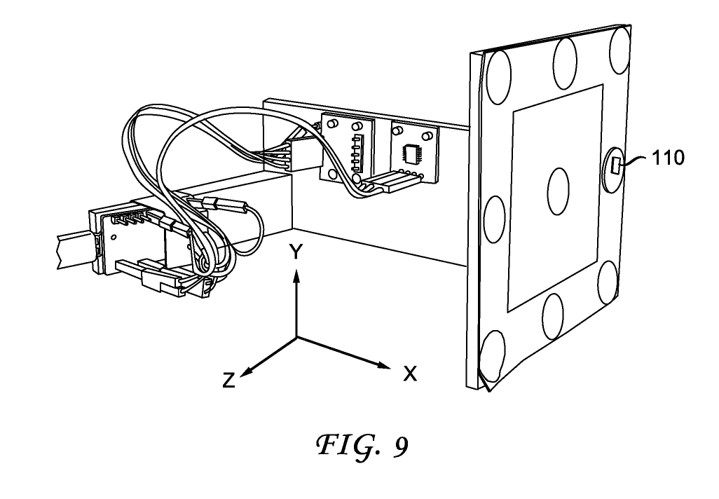

FIG. 1 shows a virtual reality (VR) enclosure used in conjunction with mobile devices such as smartphones. FIG. 9 is an illustration of an experimental setup that is provided to reflect the different coordinates of a VR enclosure similar to the embodiment of FIG. 1. As shown in FIG. 1 and FIG. 9, a magnet 110, is disposed on the side of the conventional VR device and enclosure as shown. Traditionally, conventional enclosures such as the one illustrated in FIG. 1 by numerals 100, have become an inexpensive way to provide simple VR experiences to end users. Such enclosures are relatively cheap and therefore allow users to gain access to virtual reality applications without investing in dedicated hardware. One challenge with these types of devices is how to obtain input from the user. When a mobile phone is used, the phone is surrounded by the enclosure so the touch screen is not available. Likewise, the inertial sensors are used to track head rotations and are largely unavailable for direct user input. An additional complication is in keeping the enclosure as simple and cheap as possible. For example, while it would be possible to incorporate a touch panel in the side of the enclosure, doing so would make the enclosure more expensive and complex because it would require adding electronics to a device that is otherwise just a simple mechanical housing and cheap lens.

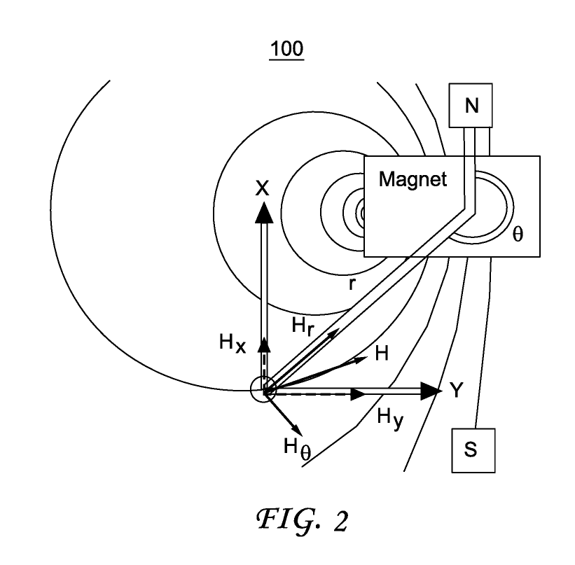

FIG. 2 is a graphical depiction of a magnetic field. A magnet generates a field composed of the tangential Hᵣ and radial components H_{θ}. A sensor placed a distance r away at the angle θ measures this field which as shown is in three dimensions and defined as:

Ĥ, in three dimensions [Ĥₓ,Ĥ_{y},Ĥ_{z}].

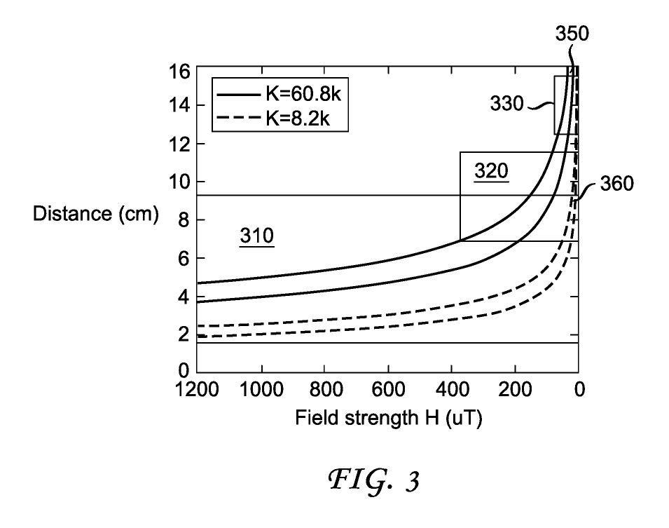

Magnetometers sense magnetic fields and have become cheap and ubiquitous with the rise of smartphones. These sensors are capable of measuring the strength of the magnetic field vector on its three orthogonal axis as shown in FIG. 3. In a smart phone, however, the field vector and the embedded magnet are typically used as a compass. In other words, they are used to measure the Earth's magnetic field but only the orientation of the field is of interest. The magnitude of the magnetic field is then discarded.

Fundamentally, a magnetic field H (μT) can be decomposed into two orthogonal component vectors, tangential Hᵣ and radial H_{θ}:

$${H}_{r} = \frac{2 K cos θ}{{r}^{3}} , {H}_{θ} = \frac{K sin θ}{{r}^{3}} , K = \frac{M}{4 π} \qquad ( 1 )$$

where K is a constant (in units of field μT in _{cm}³) related to the magnetic moment and depends on the specific permanent magnet used. r (cm) is the distance from the magnet to the sensor and θ is the angle from the north pole of the magnet to the sensor as was shown in FIGS. 1 and 2. The magnetic field is two dimensional because it is rotationally symmetric about the magnetic pole. Using trigonometry we can convert this polar representation into a Cartesian one:

$$\begin{matrix}r = \sqrt{{x}^{2} + {y}^{2}} , cos θ = - x / r , sin θ = - y / r & ( 2 ) \\ {H}_{x} = {H}_{r} cos θ - {H}_{θ} sin θ = K \cdot \frac{2 {x}^{2} - {y}^{2}}{{r}^{5}} & ( 3 ) \\ {H}_{y} = {H}_{r} sin θ + {H}_{θ} cos θ = 3 K \cdot \frac{xy}{{r}^{5}} & ( 4 )\end{matrix}$$

The above formulas allow calculation of a 2D coordinate (x,y) for use with a user interface from the magnetic field reading [Hₓ, H_{y} ]. Note that this derivation assumes the magnet and sensor are aligned with the pole parallel to the x-axis and Hz=0. If the configuration is different, the known rotation T needs to be applied to the raw sensor readings.

Applying this concept to an embodiment such as shown in FIG. 1, a side of the VR enclosure can be used for establishing input data, as per one embodiment. The user moves the magnet across the surface similar to a trackpad. However with VR enclosures, different phones have different sizes and make different design choices for their electronics. As such, the position of the magnetometer relative to the VR enclosure's magnet will vary between phone models. This geometry can be fixed for a given phone and enclosure pair and could be specified with a one-time configuration (for instance looking up the key geometry values in a database).

In one embodiment, as shown in FIG. 9, instead of using several different phone types, a 3D printed test apparatus can be used that allows to control for the position of the magnetometer relative to the interaction surface. (The design of the apparatus in this embodiment can mimic a VR enclosure for a phone).

The interaction surface where the magnet moves is the right hand vertical surface (the YZ plane). In a VR enclosure, the phone is mounted in the back of the device (away from the user) in the XY plane. In one embodiment, a test apparatus can be used that has a bar for allowing the mounting of a magnetometer in a similar configuration.

Furthermore, the magnetometer can be disposed in one of a plurality of locations. In one example, three different locations can be used for simplicity. In this example a distance from the interaction surface (along the x axis) of 1.5 cm, 7.0 cm, or 12.5 cm is used. The interaction surface in this example has an area of 8 cm×8 cm and the magnet can be moved vertically (y between −3.5 cm and +4.5 cm) and horizontally (z between 8 cm and 0 cm). In one embodiment a stand-alone magnetometer and an accelerometer/gyroscope can be connected directly to sensor. Given this configuration, Equations 3 and 4 can be used for the final calculation. When the user moves the magnet in the YZ plane which is the know distance x from the magnetometer. Furthermore, the magnet is axis aligned with the sensor. Since the magnetic field is rotationally symmetric about the pole, only need to consider is that of the plane coincident with the x-axis that passes through the pole of the permanent magnet. The magnetic field can now be measured by rotating the reading along the x-axis:

α=a tan 2(Ĥ_{z},Ĥ_{y}).

Now using Equations 3 and 4:

Hₓ=Ĥ_{z} and H_{y}=\sqrt{Ĥ_{y}²+Ĥ_{z}²}

Since x is known then there is only variable (y) to solve. To solve for y, it can also be transformed back into the Cartesian coordinate frame of the magnetometer:

ŷ=y cos α,\hat{z}=y sin α

The above formula may not always take into account the situations that include more than a single magnet. In addition to the magnet used to create the field for input, there is the magnetic field of the Earth and other ambient sources to consider. Therefore, the impact of this field must be accounted for otherwise the distance calculations will be incorrect. Furthermore, using magnetic field sensing in this way has other parameters that must be considered. In particular, some parameters to consider are the strength of the magnet, distance from the magnet to the sensors, and sensor gain that will all play a role in an overall system design.

FIG. 3 is a graphical depiction that further illustrates the relationship between the magnitude of the magnetic field H, the strength of the magnet K, orientation of the magnet and distance d. First, using the figure, it can be seen that the nature of Equation 1 is non-linear. FIG. 3, also shows the relationship between field strength, distance, strength of magnet (K) and magnet orientation (parallel vs perpendicular.) As shown two sets of K are used. The solid lines referenced as 350 are for K=60.8 k nad the dashed lines in the graph referenced as 360 are for a value of k that is equal to 8.2 k. When the magnet is far away, the magnetic field is very weak and a small change results in much larger change in d. This region provides better sensitivity to magnet movement, but the impact of sensor noise would also be more pronounced. Conversely, when the magnet is close to the sensor, the field strength is relatively large and small changes in H result in small changes in d. However, sensors have maximum operating ranges and depending on the device only results that fall within the range can be used.

In addition, FIG. 3, shows the target operating regions for the different configurations of our test apparatus as referenced by numerals 310, 320 and 330. When the sensor and magnet are close (e.g. x=1:5 cm position) as shown at the bottom rectangle referenced as 310, a large span of distances must be sensed. Furthermore, it may not be possible to sense when the magnet is close to the sensor. For example, even with a weaker magnet where K=8200, the saturation value is closer than about 2 cm. Conversely when the magnet is far away (x=12:5 cm) as shown by the top rectangle referenced as 330, the span of distances needed to sense is smaller, albeit at a larger absolute distance. This setup also provides that in the region where small differences in magnetic field readings result in large changes in calculated distance. Finally, the orientation of the magnet shifts the curves. When the magnet is parallel the field is tangential (HR) so the distance is larger for a given field strength compared to when the magnet is perpendicular and the field is radial (Ho). Examining the same figure, the impact of the ambient magnetic field can also be examined using a sensitivity analysis. The intensity of the geomagnetic field varies based on location from 22-67 μT and as above, the orientation of the permanent magnet, sensor and geomagnetic field must be considered. The worst case is when the geomagnetic field is directly aligned with the magnet so the total magnitude of the geomagnetic field is either added to or subtracted from the magnitude of the permanent magnet. The error is also greatest when the angle θ between the magnetometer and pole is at 0 (or 180) degrees. In this case:

$${H}_{r} = 2 K / {r}^{2} and {H}_{θ} = 0 therefore r = \sqrt[2]{2 K / \vert H \vert} . ,$$

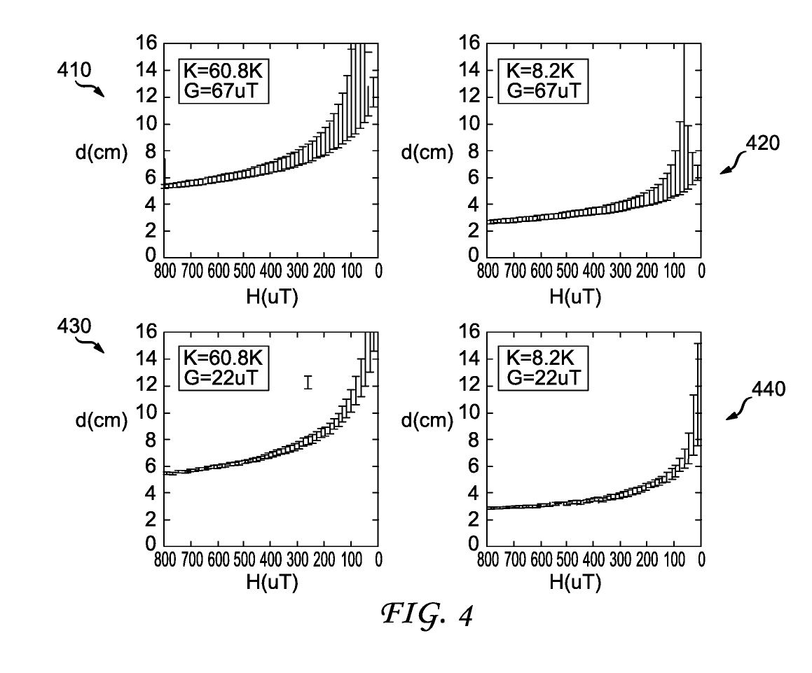

FIG. 4 is a graphical illustration showing the impact of ambient magnetic field on distance calculation. The four graphs shown and referenced as 410, 420, 430 and 440 provide the possible uncertainty in position for two different magnets and different ambient geomagnetic field strengths. When the above conditions are met, a given magnetic field reading (H) can be off by as much as +/−the magnitude of the geomagnetic field. This uncertainty in the actual value of H results in an associated uncertainty in position. For example, if the measure for H=700 μT and this occurs in a region where the ambient geomagnetic field is 67μT (FIG. 4, top-left as shown at 410), the distance from the sensor to the magnet would be somewhere between 5.69 cm and 6.07 cm. However, when the magnet is moved farther away and we measure a field of is H=100 μT, the possible position is between 9.46 cm and 16.2 cm. The uncertainty in position approaches infinity when the ambient magnetic field exactly cancels out the magnetic field of the permanent magnet (H=0). At a location where the ambient magnetic field is weaker (FIG. 4, bottom as shown at 420 and 440), then the impact on error is smaller. Unfortunately, the magnitude of the geomagnetic field cannot be closely controlled and consequently, the strength of the magnet impacts the error where stronger magnets result in larger error bounds due to the larger value of K in Equation 1 (FIG. 4 left vs right or 410/430 vs 420/440). This finding is counter to prior art's reasoning for selecting a strong permanent magnet to counteract the ambient magnetic field.

Taking this into consideration, Table 1 provide results for a static test (original value, after calibration) as provided:

TABLE 1

| (cm) | z = 7.365 | z = 4.000 | z = 0.635 |
|---|---|---|---|
| y = 3.865 | 0.179, 0.268 | 0.287, 0.086 | 0.357, 0.290 |
| y = 0.500 | 0.435, 0.675 | 0.254, 0.372 | 0.401, 0.101 |
| y = −2.865 | 1.578, 0.283 | 0.887, 0.142 | 0.471, 0.304 |

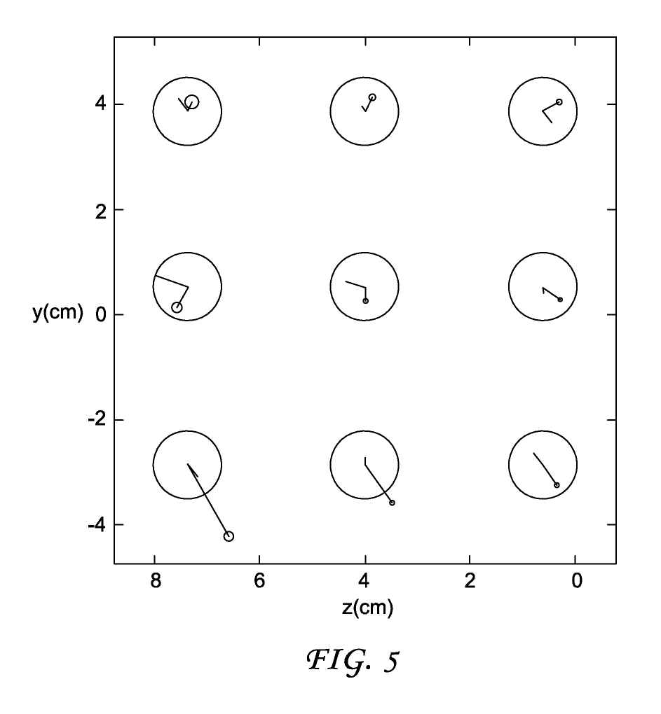

FIG. 5 is an illustration of a diagram representing a visualization of one static test conducted and results obtained. The circles indicate the mean error for each position where the red circle is the dispersion (mean of difference from the central point). Black lines without the rounded indicates represent the mean position after calibration using an affine transform. The gray circles represent the position for each test and the magnet. In this experiment, the intent was to consider the characterizing MF sensing using a static known ambient field.

The first experiment demonstrates applying these equations to sensor data in a VR enclosure configuration. The static test can be performed, for example, on a table with our apparatus so that a constant ambient magnetic field, G can be achieved. Given the above analysis, the only report shown is for data in the middle sensor position (x=7:0 cm) and a magnet where K was measured to be approximately 8200. The sensitivity can also be increased to achieve better results. For all of the magnetic field readings in the figures, first a calibration can be made for hard and soft iron effects. This means to remove the permanent magnet from the area and rotate the device around all axes. If the magnetometer can be perfectly calibrated, all of these points would lie on a sphere centered at (0,0,0) with the radius being the magnitude of the ambient magnetic field. In practice, however, there can be hard iron effects (the center is offset) and soft iron effects (the sphere is deformed into an ellipsoid). To compensate for these effects, an ellipsoid to the data is fit after removing outliers. The parameters of the ellipsoid (centroid and major/minor axes) provide the needed information to transform the raw magnetometer readings into ones where these effects are corrected. This calibration procedure is performed once and applied to every sensor reading taken from the magnetometer.

In FIG. 5, as shown, at the beginning of the static test, in this example, 500 readings were captured of the ambient field. The mean G is then calculated. During the test, this vector is subtracted from each magnetic field reading:

H=Ĥ−G (5)

In this example. To achieve representative data, a printed template was used attached to a 8 cm×8 cm interaction with 9 positions and manually placed the magnet in each location as was previously shown in FIG. 1). In this example, 500 readings were collected for each position and previous equations were used to calculate the location of the magnet. FIG. 5 and Table 1 show the difference between the mean calculated position and ground truth. The maximum error across these nine positions is about 1.6 cm. These errors are relatively systematic and probably result from the 3d printed apparatus and sensor not being exactly aligned. However, a cheap VR enclosure (for instance made of cardboard) might suffer from this problem as well. A simple calibration could improve this error. To demonstrate, an affine transformation is computed using the known location of the four corners. After applying the transformation, the errors are reduced to less than 0.7 cm (FIG. 5, black lines without the round indicators).

For comparison, the magnet itself is 1.27 cm in diameter. Overall, this data provides the conclusion that if somehow the ambient magnetic field can be removed, one can obtain good 2D position measurements for user input on a VR enclosure. Unfortunately, as discussed the ambient field can have a very large impact on the position measurements.

In one embodiment, a device rotation scheme can be used to resolve these issues. In one embodiment, a VR enclosure is provided that will not be stationary and therefore the strategy from the previous experiment of estimating the ambient field first and assuming it remains constant can provide to be unrealistic. To demonstrate the impact of not accounting for the direction of the ambient field, a second experiment similar to the previous one can be conducted. Here, the device is oriented so that the ambient field is aligned with the Z axis (0 degrees) and measure the ambient magnetic field at the beginning of the experiment as before:

(G=[2.35,−26.39,20.38],|G|=33.42).

In one embodiment, the magnet is placed in a single position (in the middle at z=4 cm, y=0.5 cm) and rotate the whole apparatus about the Y axis at 22.5 degree increments through a full circle. At each position, we again collect 500 readings and subtract the initially determined magnetic field vector G from each (Eq. 5). The mean position of the magnet can then be calculated.

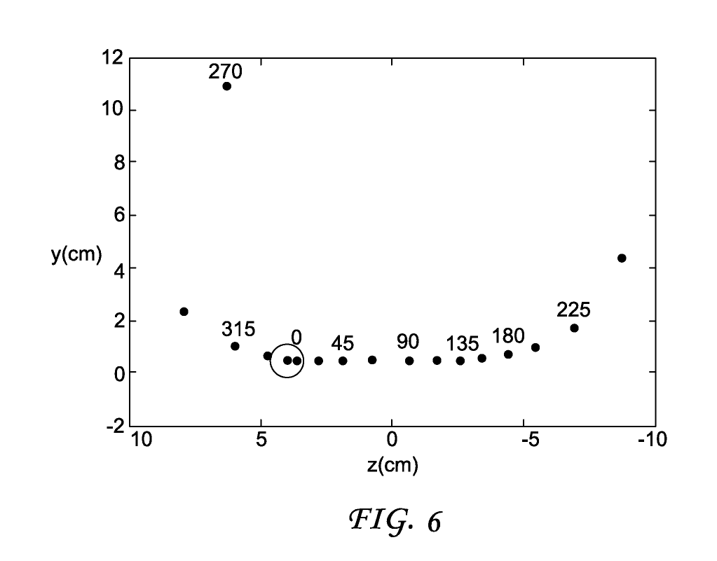

FIG. 6 is a graphical depiction of the results of the experiment conducted. Resulting errors were due to rotation of the device combined with not taking into account the corresponding counter rotation of the ambient field. The gray circle and points disposed in the circle are the ground truth position. Each black point represents the calculated position at a given angle. As seen in FIG. 6, at zero degrees the position is reasonably accurate. However, as rotation occurs through the circle, there is significant increase in error coefficient (much larger than the interaction area).

To compensate for the ambient field, fundamentally, the challenge is with using magnetic field sensing for VR enclosure. That is that the field can change for one of two reasons. It varies as the user moves the magnet to provide input as intended. It also changes as the user moves the VR enclosure around to look at different elements in the virtual world. The above data and analyses show the error introduced by movement can be enough to make the distance calculations useless for input. While carefully selecting the strength of the magnet or position of the magnetometer might mitigate the impact, it does not address this issue. It is impossible to differentiate between these two with just the one magnetometer in a phone. In one embodiment the inertial sensors in the phone is used.

In one embodiment, phone movement may be tracked by allowing the user only move the magnet or only the VR enclosure, As long as both of these two components are not moved at the same time, there will be no issues. When just the magnet is moving, the above solution can be applied where first the value is estimated and then geomagnetic field (Eq. 5) is subtracted. G in this case will be treated as a constant. H is determined by applying Equations 3 and 4. When the VR enclosure moves and the magnet is stationary, the opposite can be performed as shown below:

G=Ĥ−H (6)

The field generated by the magnet H is treated as constant since the user is not moving it and we re-determine G. Having a mode for tracking phone movement versus allowing input could be permissible depending on the interactions exposed to the user. However, asking the user to stay perfectly stationary while providing input is not feasible. Consequently, a way to track the changing orientation of G is needed while also allowing the user to move the magnet. Fortunately, the VR enclosures must already estimate the rotation of the phone so it can create the right viewport into the virtual environment. The same approach can be used to track the orientation of the ambient magnetic field as the user moves. In other situations, orientation can be tracked using the accelerometer and the magnetometer. These sensors form a basis (measuring gravity pointing down and the Earth's magnetic field pointing north) for determining absolute orientation. However, since some devices use the magnet for input, they forego the magnetometer and instead must rely on fusing the accelerometer and gyroscope. For example, a mobile device may use web browsers which uses a complimentary filter to fuse accelerometer and gyroscope sensor readings. By integrating the measurements of rotational velocity over time and fusing them with the gravity vector, the complimentary filter provides an estimate of the rotation matrix R that transforms the starting reference frame to the current one.

In one embodiment, an algorithm or a conventional graphics software can be used for this rotation to create the right view port into the virtual world. This can be used to track G. As such, a gyroscope and accelerometer was added to the test apparatus (FIG. 1) and used. The magnet was used in a known position so that the associated magnetic field reading H could be stored in the same database as the relative position of sensor and interaction surface, as per one embodiment. Now Equation 6 can be used to obtain an initial measurement Gi. As the user rotates the VR enclosure, we re-estimate the orientation of the phone (R) using the inertial sensors and apply the associated transform is:

G=R·Gᵢ (7)

This approach allows the user move both their head (and the VR enclosure) as well as the magnet simultaneously if desired. The inertial sensors can track G as the user moves and Equation 5 (and in turn Equations 3 and 4) can be used to obtain the 2D position of the magnet when accurate devices are used. However, where precision instruments are not used, the use of the gyroscopes can cause have both drift and noise. To make account of this situation (and given how sensitive it is to have an error or any incorrect magnetic field readings—see FIGS. 4 and 6), it is not feasible to track the orientation indefinitely. Therefore, the solution for such an embodiment is to rely upon user interactions that have modal input. Therefore, in such situations and by default, the magnet is not being used for input and the user is looking around the virtual environment. The magnet starts in a known position so we can continually calculate the ambient magnetic field (Eq. 6). At a certain point, the user transitions into the input mode where we save the current measurement Gi=G and then start tracking G. The user can move both the magnet and the enclosure as desired. When the user exits the input mode, the last value of H is saved, and the system goes back to calculating G. This approach can suffer from IMU drift; however, the drift only accumulates while in the input mode. And since drift is proportional to tracking time, this solution works for VR applications that utilize short bursts of 2D input.

In another embodiment and using another approach to minimize the impact of drift, one can have magnet return to a known position after each input session. In some earlier prior art devices, a second fixed magnet was used on the inside of the device so that input magnet would re-center. Unfortunately, later devices have removed this option and the option so this option no longer available to determine the location of the two separate magnets (and associated magnetic field) with just the one magnetometer. Therefore, an embodiment can be provided that is designed so the user positions the magnet in a known location. In this case, there is the potential for some drift during input, but it does not accumulate from session to session. For instance, a detent could be created on the surface of the device so the user can return the magnet to a known position. In one example, the user can make gestures along the edge of the device to enter letters of the alphabet. However by design, the user also always stops a given gesture in a known corner. That position would let the system reset to a known magnetic field reading H and determine the current ambient field reading G.

As can be appreciated by those skilled in the art, different implementations can be provided. In one example, as was shown and discussed in conjunction with FIG. 1, a system for 2D input can be provided. In one example, a plurality of with discrete sensors and any microcontroller based devices, component or kits (one example being Arduino) or other similar devices as can be appreciated by those skilled in the art. Sensor data is sent to a mobile device, such as a laptop for processing and the code is also provided to solve the magnetic field equations appropriate software (i.e. Python etc.). In this example, for tracking, a complementary filter implementation is used. In one embodiment, any user interface even a simple one can be used as long as it shows the magnetometer readings and two representations of the calculated magnet position. As can be appreciated by those skilled in the art, other mobile devices such as smart phones can also be used.

In a second example, a version of the system is implemented for use in a VR enclosure. In one embodiment, a mobile phone or smart phone can be used and sensor data can be obtain (for example Objective C code can be used to obtain “raw” sensor data). For example, startMagnetometerUpdatesToQueue:withHandler can be used to obtain CMMagnetomete sensor events. In such an example, the result that is obtained will show that the readings are directly acquired from the sensor. In other embodiments, further processing by the processor is needed (by obtaining information from both firmware or at operating system level) when strong magnetic fields are present in close proximity and affecting the calibration of the sensor data. In another embodiment, (where raw events are used) hard and soft iron corrections for the smart phone can also be used. The latter step can provide solutions to minimize significant hard iron effects, likely due to the close proximity of the magnetometer such as to the ear of a user/speaker.

Unlike the previous example of a test apparatus, the exact position of the phone magnetometer may not be known. However, by examining magnetometer data, one can estimate that it is approximately ion a certain range. For example, in one mobile phone example, the measure range was about 1.1 cm from the top of the phone and 1.9 cm from the left.

In instances where the magnetometer is provided close to the edge, as was shown in FIG. 3, a (permanent) magnet would likely saturate the sensor if the top of the phone is placed on the end of a VR enclosure used for input. Therefore, in such a case, the reverse configuration can be used. In one example, the estimated distance from the sensor to the interaction surface has provided x=12:3 cm. Also, since the sensor and magnet are far apart and we have no direct control of sensitivity, a much stronger magnet can be used where K is approximately 44000. In one case, two magnets forming a sandwich can be used. In this case, one magnet can be disposed on the outside and manipulated by the user while a second magnet can be disposed on the inside which is moved with the first. This first magnet, can in one embodiment, hold the second magnet on the outside in place when the user finally relinquishes it. In practical situation, where there is a lot of sensor noise in the readings, one can apply an exponential moving average to the magnetometer data for smoothing out the noise.

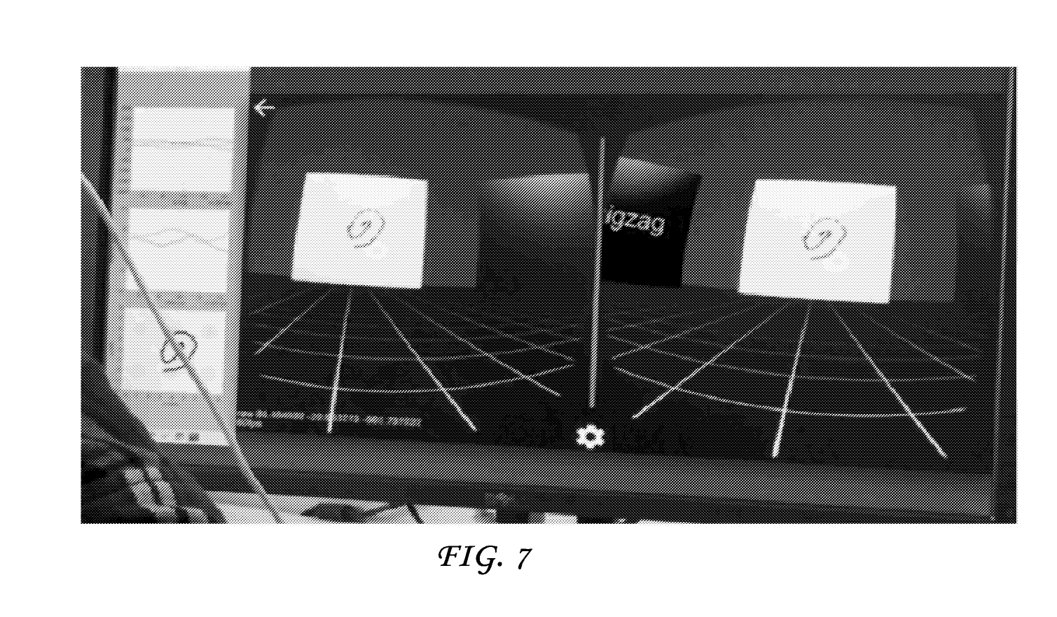

To aid understanding, several different interaction examples can now be used in conjunction with the different embodiments. Each example is a plane positioned in three dimensional (3D) environment. In the examples, in one embodiment, to enter the input mode, the user places a “gaze” cursor on a component (i.e. a widget) by rotating the VR device. After some time, as short as two seconds, the system switches modes which is visually indicated by changing the color of the surface. At this point, the system starts tracking device rotation to estimate G and also calculates the 2d position of the magnet which is used by the user interface. When the gaze cursor leaves the component or the widget, the system returns to tracking only mode. To demonstrate this in one example, the depiction of FIG. 7 can be used.

FIG. 7 provides a first example. IN FIG. 7, the user of the input is a novice and the user interface is used to input information needed to draw a figure such as a spiral. The interface, in one embodiment, paints a point for each position that is calculated on the surface. When a smart phone is used, the phone screen is mirrored to the monitor and raw magnetometer and position information is displayed in the window on the left. In the example shown in FIG. 7, the user can be making gestures to provide the user input (in order to draw the spiral). In this example, the user may be making selections by gesturing such as along the edge of the device to enter letters of the alphabet. However by design, the user also always stops a given gesture in a known corner. That position would let the system reset to a known magnetic field reading H and determine the current ambient field reading G.

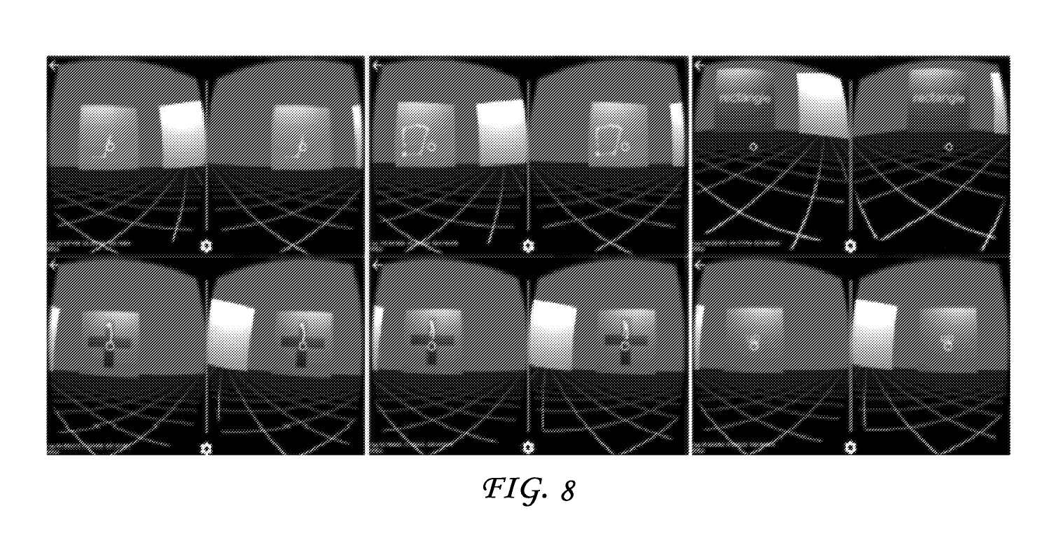

In a second example is provided in FIG. 8. In FIG. 8, three different examples of widgets using the $P gesture recognizer is provided as recognizer to input a rectangle (top) and a D-Pad widget to input “up” (bottom). In this second example, the implementation can work with gesture recognition. In this particular example, a Unity3D port of the $P gesture recognizer is used and for debugging, the individual points are rendered as they are calculated. Once the user exits the application associated with the component (widget) the recognizer processes the points and displays the result of gesture recognition. This is shown in the top portion of FIG. 8.

In a third example can also be understood in conjunction with FIG. 8. IN this example a component (i.e. widget) is provided that is similar to a simple 4 way D-pad (FIG. 8, bottom). In this case, the user activates the device r component and moves the magnet in any of the 4 cardinal positions, then returns it to the center. In one embodiment, the direction detected is displayed onscreen. This example provides one embodiment where an interaction does not have the cumulative error of tracking the magnet from input session to input session. In this embodiment, the assumption is that the user starts with the magnet in the center of the input area and finishes in the same position.

In using magnetic field sensing for 2D input, the ambient magnetic field can have a significant impact. However, a detailed tracking device orientation using the inertial sensors, allows the embodiments discussed to successfully use the magnet for user input. In addition, the APIs available do not provide the same level of access to the sensors as a direct hardware API. Also, mobile phone platforms offer several soft sensors that utilize a variety of filtering and sensor fusion algorithms to overcome some of the limitations of the sensors or compensate for known but proprietary factors impacting the sensors. In one embodiment, an API can be created that allows a developer to leverage the processing the phones are doing on the sensor data but that also takes into account the presence of relatively large moving magnetic field that can be used for input in some embodiments.

In addition, in one embodiment, a holistic system that tracks all of the unknown variables is provided. Given the above API issues, in one embodiment a standalone tracking system based on a complementary filter can be used but in alternate embodiments.

In a different embodiment, where a strong pair of magnets is needed to create a sufficiently large signal, it can be difficult to slide the magnet over the surface due to the force exerted between the magnets. In such cases, a coating can be applied to the magnets with a lower coefficient of friction to help with handling. In a different embodiment, a handle can be added for the magnet to provide for easier input. The handle could both reduce friction between the magnet and the device cardboard surface and even provide a better point for grasping the magnet with the fingers allowing for easier actuation.

Finally, while simple interaction examples were discussed to demonstrate the capability of our system to provide 2D input, it should be understood that interactions where the position of the magnet at the start or end of a movement is known can also be considered. Doing so would minimize any cumulative tracking errors. In alternate embodiment, a switch between tracking and input modes can be explored and in other embodiments techniques to create or adapt existing VR input to make use of our continuous 2D pointing capability can be implemented.

Virtual Reality enclosures provide a cheap and simple way to experience VR content. However, given that cost and simplicity is such a driving factor in their design, there are limited opportunities for input. In different embodiments, as discussed, different ways to use a magnet for input can be explored from the simple to the more complex including replacing magnets only for use as a binary to using the magnetic field sensing to provide continuous 2D input. By tracking the orientation of the ambient magnetic field using the inertial sensors in the phone, one can successfully calculate the 2D position of the magnet using the embodiments discussed.

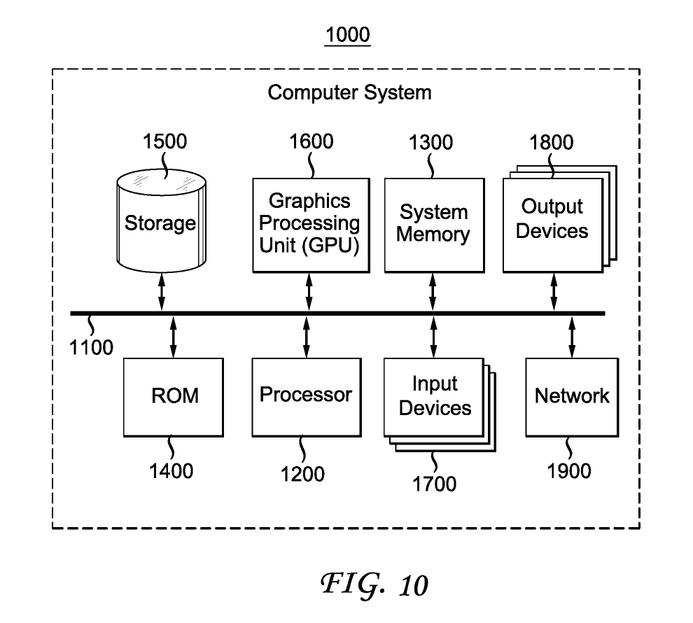

FIG. 10 is a schematic block diagram illustration of a computer system 1000. The computer system 1000 can be representative of the smart phone as discussed in conjunction with FIG. 1. In one embodiment, the computer system 1000 is accessed through a smart phone or mobile device but not all components as shown are encompassed in the smart phone or mobile device. In other embodiments, the computer system 1000 may also include the mobile device including the smart phone used in conjunction with the VR enclosure of FIG. 1 but also incorporate various other devices such as one or more personal computers (“PC”), servers, other mobile devices, smart phones and tablet devices, and/or any other appropriate devices as can be appreciated by those skilled in the art. The various devices may work alone (e.g., the computer system may be implemented as a single PC) or in conjunction (e.g., some components of the computer system may be provided by a mobile device while other components are provided by a tablet device). The computer system 1000 may include one or more bus or bus systems such as depicted by 1100, at least one processing element 1200, a system memory 1300, a read-only memory (“ROM”) 1400, other components (e.g., a graphics processing unit) 160, input devices 1700, output devices 1800, permanent storage devices 130, and/or a network connection 1900. The components of computer system may be electronic devices that automatically perform operations based on digital and/or analog input signals.

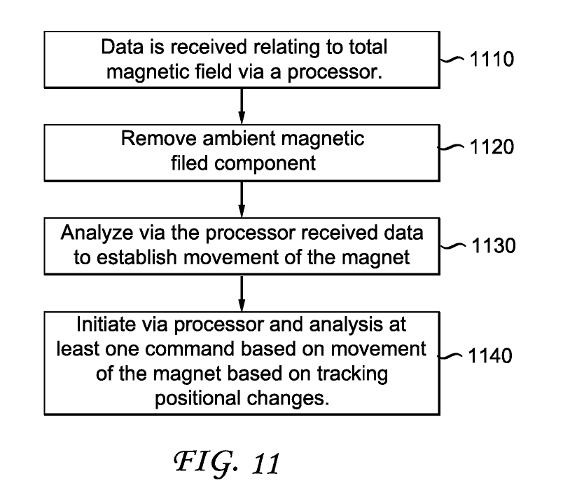

FIG. 11 is a flow diagram illustrating a method for determining user input as per one embodiment. In step 1100 data is received continuously regarding total magnetic field readings via a processor. Some of the magnetic field measurements are due to a magnet connected to a user interface and input to said user interface causes positional changes to the magnet as discussed. In step 1120 the processor removes any ambient magnetic field components from the magnetic field readings. In step 1130, the processor analyzes changes in the magnetic field readings and determines when the changes are due to positional changes of a magnet in proximity to the user interface. In step 1140, the processor initiates at least one command based on tracking positional changes of the magnet.

While some embodiments has been described, it will be understood that those skilled in the art, both now and in the future, may make various improvements and enhancements which fall within the scope of the claims which follow. These claims should be construed to maintain the proper protection for the invention first described.

What is claimed is:

1. A method for determining user input comprising:
receiving continuous total magnetic field readings via a processor, wherein some of said magnetic field measurements are due to a magnet connected to a user interface and input to said user interface causes positional changes to said magnet;
removing via said processor any ambient magnetic field components from said magnetic field readings;
analyzing via said processor changes in said magnetic field readings and determining when said changes are due to positional changes of a magnet in proximity to said user interface;
initiating via said processor at least one command based on tracking positional changes of said magnet.

2. The method of claim 1, wherein said removing step further comprises:
receiving, during a plurality of intervals, a direction and magnitude of an ambient magnetic field in any vector direction via a magnetometer; and
tracking said direction and magnitude of said ambient magnetic field continuously via said processor using said received direction and magnitude so that said ambient magnetic field component can be removed from said total magnetic field reading.

3. The method of claim 2, further comprising:
establishing a location of said magnet using said received direction and magnitude and establishing an initial magnetic field measurement of said magnet prior to receiving any user input;
tracking said direction and magnitude of said magnetic field connected to said magnet continuously via said processor using said received direction and magnitude so that said ambient magnetic field component can be removed from said total magnetic field reading.

4. The method of claim 2, further comprising receiving a measurement for said ambient magnetic field from said magnetometer and tracking said direction and magnitude and measurement of said ambient magnetic field via said processor using said received so that said ambient magnetic field component can be removed from said total magnetic field reading.

5. The method of claim 2, wherein said magnet is disposed on a housing.

6. The method of claim 2, wherein said housing is configured to receive a mobile device.

7. The method of claim 6, wherein said magnetometer is disposed in said mobile device.

8. The method of claim 7, wherein said housing is a virtual reality wearable housing and said magnet is disposed on said housing.

9. The method of claim 8, wherein changes to said housing causes positional changes to said magnet.

10. The method of claim 9, wherein said processor receives information about exact location of said magnet.

11. The method of claim 10, wherein only said ambient magnetic field is continually calculated until a user input mode is entered, at which time a current ambient magnetic field measurement field is stored.

12. The method of claim 11, wherein magnetic field from movement of said magnet is calculated during user input mode.

13. The method of claim 12, wherein upon exiting of said input mode, a last value of total magnetic is saved, and said processor returns to only measuring said ambient magnetic field continually.

14. The method of claim 5, wherein said processor is disposed on said housing.

15. The method of claim 7, wherein said processor is disposed on said mobile device.

16. An apparatus for determining user input comprising:
a housing configured to receive a mobile device and having a user interface;
a magnet in proximity to said user interface such that input provided to said user interface causes positional changes to said magnet;
a processor configured to receive continuous total magnetic field readings, wherein some of said magnetic field measurements are due to magnetic field of said magnet;
said processor configured to remove any ambient magnetic field components from said total magnetic field readings and initiate at least one command when said processor determines that changes in said magnetic field readings are due to positional changes of said magnet in proximity to said user interface.

17. The apparatus of claim 16, wherein removing ambient magnetic field component from said total magnetic field reading comprises said processor receiving, during a plurality of intervals, a direction and magnitude of an ambient magnetic field in any vector direction via a magnetometer associated with said mobile device.

18. The apparatus of claim 17, wherein said processor is further configured to track said direction and magnitude of said ambient magnetic field continuously via using said received direction and magnitude so that said ambient magnetic field component can be removed from said total magnetic field reading.

19. The apparatus of claim 18, wherein said processor is configured to establish a location of said magnet using said received direction and magnitude and said processor is further configured to establish an initial magnetic field measurement of said magnet prior to receiving any user input such that said direction and magnitude of said magnetic field connected to said magnet can be tracked continuously using said received direction and magnitude so that said ambient magnetic field component can be removed from said total magnetic field reading.

20. The apparatus of claim 19, wherein said processor receives a measurement for said ambient magnetic field from said magnetometer and tracks said direction and magnitude and measurement of said ambient magnetic field using said received so that said ambient magnetic field component can be removed from said total magnetic field reading.
